(19) United States
(12) Patent Application Publication
(10) Pub. No.: US 2025/0103585 A1
(43) Pub. Date: Mar. 27, 2025

(54) IMAGE LOG MANAGEMENT SYSTEM, NON-TRANSITORY COMPUTER READABLE MEDIUM STORING IMAGE LOG MANAGEMENT PROGRAM, AND IMAGE LOG MANAGEMENT METHOD

(71) Applicant: FUJIFILM Business Innovation Corp., Tokyo (JP)

(72) Inventor: Hiroki HONJO, Kanagawa (JP)

(73) Assignee: FUJIFILM Business Innovation Corp., Tokyo (JP)

(21) Appl. No.: 18/587,990

(22) Filed: Feb. 27, 2024

(30) Foreign Application Priority Data
Sep. 25, 2023 (JP) 2023-159991

(51) Int. Cl. G06F 16/23; G06T 3/40

(52) U.S. Cl. CPC G06F 16/2379; G06T 3/40

(57) ABSTRACT

An image log management system includes plural devices that each store a blockchain including a block having transaction information including image logs that are image data indicating process target data, and are communicably connected to each other, and a processor, in which the processor is configured to generate new transaction information including image logs of a resolution decided based on a frequency of addition of plural latest blocks added to the blockchain, and transmit the new transaction information to the plural devices and add a block having the new transaction information to the blockchain.

### CROSS-REFERENCE TO RELATED APPLICATIONS

This application is based on and claims priority under 35 USC 119 from Japanese Patent Application No. 2023-159991 filed Sep. 25, 2023.

### BACKGROUND

### (i) Technical Field

The present invention relates to an image log management system, a non-transitory computer readable medium storing an image log management program, and an image log management method.

### (ii) Related Art

In the related art, in a case where a process is executed on process target data, image data indicating the process target data is left as image logs.

For example, JP2011-28606A discloses an image forming device including a first memory provided in the image forming device and a second memory connected to the image forming device from the outside, in which the image forming device stores log information including image data indicating a job (for example, a print job or a copy job) executed in the image forming device in the first memory and the second memory.

### SUMMARY

In a case where the image logs as described above are tampered with, an original function of the image logs may not be able to be exhibited. Therefore, for example, the image logs may be managed so that the image logs are not tampered with.

Here, a technique called blockchain is known. The blockchain has a structure in which data units called blocks including transaction information including recording target information are connected like a chain. The blockchain is stored in each of a plurality of devices (also referred to as nodes) that can directly communicate with each other. Such a mechanism suppresses tampering with recording target data. By managing the image logs with the blockchain, in other words, by including the image logs in the transaction information included in each block configuring the blockchain, the tampering with the image logs can be suppressed.

In a case where the image logs are managed with the blockchain, a problem may occur in that a frequency at which the transaction information (specifically, a block including the transaction information) including the image logs are added to the blockchain (specifically, a frequency of addition of the transaction information in the present specification) is low. For example, in a case where the frequency of addition of the transaction information to the blockchain is low, a problem occurs in that unprocessed transaction information is accumulated.

In particular, since the image data such as the image logs generally has a larger data volume than the data (for example, transaction information of virtual currency) managed with the blockchain, a decrease in the frequency of addition of the transaction information is likely to be a problem.

Aspects of non-limiting embodiments of the present disclosure relate to an image log management system, a non-transitory computer readable medium storing an image log management program, and an image log management method that suppress a decrease in a frequency of addition of transaction information in a case where image logs are managed with a blockchain as compared to a case where a resolution of the image logs included in the transaction information are fixed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image log management system including a plurality of devices that each store a blockchain including a block having transaction information including image logs that are image data indicating process target data, and are communicably connected to each other, and a processor, in which the processor is configured to generate new transaction information including image logs of a resolution decided based on a frequency of addition of a plurality of latest blocks added to the blockchain, and transmit the new transaction information to the plurality of devices and add a block having the new transaction information to the blockchain.

### BRIEF DESCRIPTION OF THE DRAWINGS

Exemplary embodiment(s) of the present invention will be described in detail based on the following figures, wherein:

FIG. 1 is a schematic configuration diagram of an image log management system according to the present exemplary embodiment;

FIG. 2 is a schematic configuration diagram of an image processing device according to the present exemplary embodiment;

FIG. 3 is a conceptual diagram showing a structure of a blockchain;

FIG. 4 is a conceptual diagram showing a content of a header of a block;

FIG. 5 is a conceptual diagram showing a content of transaction information; and

FIG. 6 is a flowchart showing a flow of a process of the image processing device according to the present exemplary embodiment.

### DETAILED DESCRIPTION

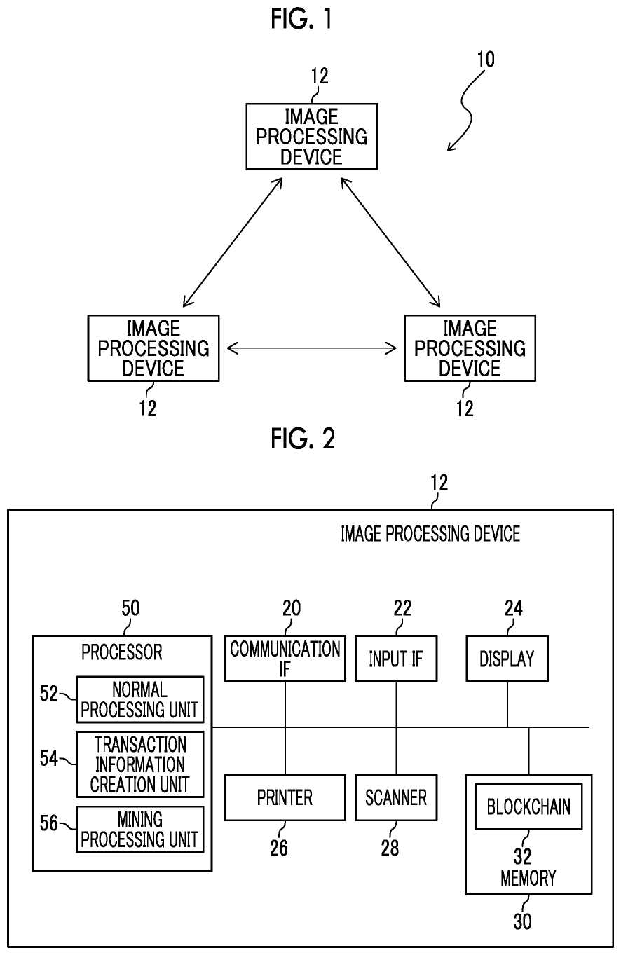

FIG. 1 is a schematic configuration diagram of an image log management system 10 according to the present exemplary embodiment. The image log management system 10 includes a plurality of devices that are a plurality of nodes of a blockchain. In the present exemplary embodiment, the image log management system 10 is configured with a plurality of image processing devices 12 as the plurality of nodes of the blockchain. In the present specification, the image processing devices 12 provided in the image log management system 10 will be simply referred to as the image processing device 12. The image processing device 12 is a device having a print function, a copy function, a scan function, a FAX function, and the like, and is, for example, a multifunction peripheral. It should be noted that, although only three image processing devices 12 configuring the image log management system 10 are shown in FIG. 1, the image log management system 10 may include three or more image processing devices 12.

The image processing devices 12 are communicably connected to each other by peer to peer (P2P) via a communication line such as a local area network (LAN) or a wide area network (WAN). The P2P is a communication method in which devices directly communicate with each other without using a server.

In the image log management system 10 according to the present exemplary embodiment, the image logs formed in each image processing device 12 are managed with the blockchain, and thus the loss of the image logs or the tampering with the image logs is suppressed. The image logs are image data indicating process target data in the image processing device 12. For example, in a case where the image processing device 12 executes a print process, the image data that is print target is the image logs. It should be noted that the process target data is not limited to the image data that is the print target. The image logs are used for, for example, suppressing information leakage, tracking, and effectively utilizing for business. Specifically, for example, the image logs are used to manage, monitor, and track when, who, and what kind of process is executed in which image processing device 12.

As described above, the data volume of the image logs is likely to be larger than the data volume of data generally managed with the blockchain, such as transaction information of virtual currency. In addition, since the image logs are the image data, the data volume is larger as the resolution is higher, and the data volume is smaller as the resolution is lower.

Although details will be described later, the blockchain is a form of a distributed database in which a plurality of blocks are connected to each other. The distributed database here refers to that an identical content of the blockchain is stored in each of the image processing devices 12. Each block configuring the blockchain includes one or more pieces of the transaction information that is a management target. In the present exemplary embodiment, each transaction information is the image logs. In addition, each block includes a hash value of block information of an immediately previous block that is a block added to the blockchain last time (hereinafter, referred to as a hash value of the block for convenience). The block information is information including the transaction information included in the block. The hash value is a value obtained by irreversibly converting target data (here, the block information of the immediately previous block). Therefore, in a case where the transaction information included in a certain block is lost or tampered with, the hash value included in all subsequent blocks is different from the normal hash value. With such a mechanism, the loss of the transaction information or the tampering with the transaction information (image logs in the present exemplary embodiment) is suppressed.

In a case where the block can be easily added to the blockchain, a malicious user can easily add an unauthorized block (for example, a block including tampered transaction information) to the blockchain. Therefore, in the blockchain, it is common that a constraint for adding a new block is provided. One such constraint is an algorithm called proof of work (PoW). The PoW is a mechanism in which a processor of the node (in the present exemplary embodiment, the image processing device 12) of the blockchain repeats a calculation, and in a case where a calculation result satisfies a predetermined condition, a new block is permitted to be added to the blockchain. In the blockchain according to the present exemplary embodiment, the PoW is also used as a constraint for adding a new block.

A process of adding a new block to the blockchain is called a mining process. In the mining process by the PoW, the processor of the node calculates the hash value of the block by inputting a combination value obtained by combining the block information of the latest block added to the blockchain, that is, one or more pieces of the transaction information included in the block, the hash value of the immediately previous block of the block, and a value called a nonce, to a hash function. As the hash function, for example, a function such as SHA-256 is used. In a case where the calculated hash value is smaller than a predetermined threshold value (referred to as a difficulty target), the mining process is successful, and a new block is permitted to be added to the blockchain. The hash value smaller than the threshold value is referred to as a correct answer hash value. In a case where the calculated hash value is equal to or larger than the threshold value, the processor changes the value of the nonce and recalculates the hash value. It should be noted that, due to the characteristics of the hash function, the output hash value greatly changes in a case where the input data (here, the value of the nonce) is slightly different. As described above, the processor repeatedly calculates the hash value while changing the value of the nonce until the hash value is smaller than the threshold value (in other words, until the correct answer hash value is obtained). Generally, the amount of calculation required to obtain the correct answer hash value is huge.

As described above, a huge amount of calculation is required to succeed in the mining process. Therefore, it is proposed to execute the mining process in cooperation with the plurality of nodes. A group of nodes that execute the mining process in cooperation with each other is called a mining pool. Also in the present exemplary embodiment, the plurality of image processing devices 12 may form the mining pool, and the plurality of image processing devices 12 (more specifically, the processors) cooperate with each other to execute the mining process.

FIG. 2 is a schematic configuration diagram of the image processing device 12. The image processing device 12 executes the print process, a scan process, a copy process, a FAX process, and the like as the process of the image processing device 12. In the present specification, such a process of the image processing device 12 is referred to as a normal process. The image processing device 12 in the present exemplary embodiment executes a mining process in addition to the normal process. Since the image processing devices 12 provided in the image log management system 10 have the same configuration, one image processing device 12 will be described here.

The communication interface (IF) 20 is configured with, for example, a network adapter or the like. The communication IF 20 exhibits a function of communicating with another device via a communication line. In particular, in the present exemplary embodiment, the communication IF 20 exhibits a function of communicating with the other image processing devices 12 by the P2P.

An input IF 22 is configured with, for example, a button or a touch panel. The input IF 22 is used in a case where the user inputs an instruction to the image processing device 12.

A display 24 is configured with, for example, a liquid crystal display, an organic electro luminescence (EL) display or the like. Various screens are displayed on the display 24 in response to an instruction from a processor 50 described later.

A printer 26 is, for example, a laser printer or an inkjet printer, and is a mechanism that executes the print process of forming an image on a print medium such as paper based on an input print job. In a case where the printer 26 is a laser printer, the printer 26 is configured with, for example, a photosensitive drum, a charging roller, a transfer roller, a fixing roller, a toner, and the like. In a case where the printer 26 is an inkjet printer, the printer 26 is configured with nozzles, a charging electrode plate, a deflection electrode plate, ink, and the like.

A scanner 28 is configured with a light source, an image sensor such as a charge-coupled device (CCD), or the like. The scanner 28 is a mechanism that executes the scan process of optically reading a paper medium to acquire image data.

The memory 30 includes a hard disk drive (HDD), a solid state drive (SSD), an embedded multimedia card (eMMC), a read only memory (ROM), a random access memory (RAM), and the like. An image log management program for operating each unit of the image processing device 12 is stored in the memory 30. It should be noted that the image log management program can be stored in, for example, a computer readable non-transitory storage medium such as a universal serial bus (USB) memory or an SD card. The image processing device 12 can scan and execute the image log management program from such a storage medium. As shown in FIG. 2, the memory 30 stores a blockchain 32.

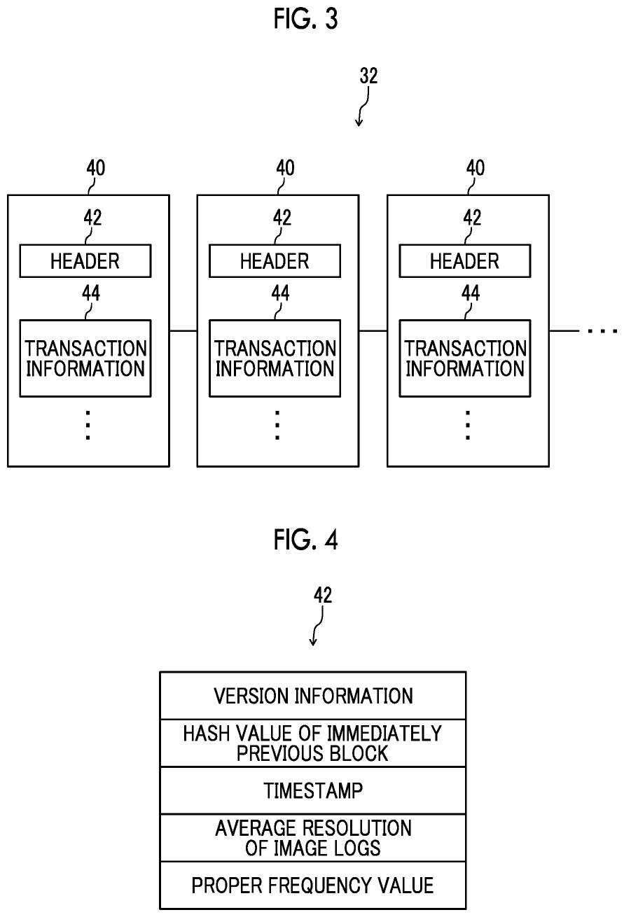

FIG. 3 is a conceptual diagram showing a structure of the blockchain 32. As described above, the blockchain 32 has a structure in which a plurality of blocks 40 are connected. Each block 40 includes a header 42 and transaction information 44.

FIG. 4 is a conceptual diagram showing a content of the header 42 included in each block 40. As shown in FIG. 4, in the present exemplary embodiment, the header 42 includes version information, a hash value of the immediately previous block 40, a timestamp, an average resolution of the image logs, and a proper frequency value. The version information is information indicating a version of software or a protocol related to the blockchain 32. The hash value of the immediately previous block 40 is the correct answer hash value calculated in a case where the immediately previous block 40 is added to the blockchain 32. The timestamp is information indicating a time at which the block 40 is added to the blockchain 32. The average resolution of the image logs is an average resolution of one or more image logs included in one or more pieces of the transaction information 44 included in the block 40. The proper frequency value is information indicating a proper value for the frequency of addition of the block 40 to the blockchain 32. A method of generating the header 42 or a method of using each information included in the header 42 will be described later.

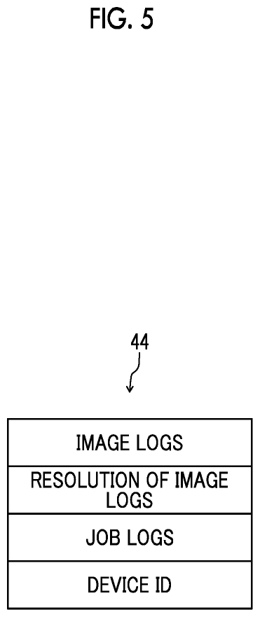

FIG. 5 is a conceptual diagram showing a content of the transaction information 44 included in each block 40. As shown in FIG. 5, in the present exemplary embodiment, the transaction information 44 includes image logs, information indicating a resolution of the image logs, job logs related to a job related to the image logs, and a device ID. The image logs are image data indicating the process target data in the image processing device 12 as described above. The job logs include, for example, a job ID for uniquely identifying the job, a user ID for uniquely identifying the user who executes the job, information indicating a type of the job (for example, print, scan, copy, FAX, or the like), and a reception date and time of the job. The device ID is an identifier for uniquely identifying the image processing device 12 that executes the process related to the image logs.

With reference to FIG. 2 again, the processor 50 is configured with, for example, a central processing unit (CPU). The processor 50 is communicably connected to the communication IF 20, the input IF 22, the display 24, the printer 26, the scanner 28, and the memory 30 via a data bus. The processor 50 exhibits functions as a normal processing unit 52, a transaction information creation unit 54, and a mining processing unit 56 by the image log management program stored in the memory 30.

The normal processing unit 52 and the transaction information creation unit 54 are mostly functions related to the creation and transmission of the transaction information 44 included in the block 40.

The normal processing unit 52 executes control for executing the normal process, based on a job as a process instruction input to the image processing device 12 by the user. For example, the normal processing unit 52 causes the printer 26 to execute the print process in a case where the print job is received from the user. In addition, for example, the normal processing unit 52 causes the scanner 28 to execute the scan process in a case where a scan job is received from the user. Specifically, the normal processing unit 52 receives the job from the user via the communication IF 20, authenticates the user, and executes the process related to the job in a case where there is an instruction from the authenticated user.

In a case where the normal process is started under the control of the normal processing unit 52, the transaction information creation unit 54 creates the transaction information 44 (see FIG. 5) related to the normal process. Specifically, the transaction information creation unit 54 sets the resolution of the image logs related to the job related to the normal process, and then generates the image logs. In addition, the transaction information creation unit 54 acquires the job logs of the job and the device ID of the image processing device 12 (which may be stored in the memory 30 in advance), and includes the acquired information in the transaction information 44. The details of the setting process of the resolution of the image logs by the transaction information creation unit 54 will be described later. It should be noted that, in the present specification, the transaction information 44 before being added to the blockchain 32 is referred to as new transaction information 44. The transaction information creation unit 54 simultaneously transmits the created new transaction information 44 to the other image processing devices 12 provided in the image log management system 10.

In this way, in a case where the normal process is executed in each image processing device 12 provided in the image log management system 10, the new transaction information 44 is simultaneously transmitted from the image processing device 12 that executes the normal process to the other image processing devices 12. Each image processing device 12 accumulates and stores the transaction information 44 acquired from any of the plurality of image processing devices 12 provided in the image log management system 10 (including the image processing device 12), in the memory 30.

It should be noted that, although details will be described later, the transaction information creation unit 54 may not be able to generate the image logs having an appropriate resolution. In the present exemplary embodiment, the generation of the image logs having an appropriate resolution is a process completion condition of the job. Therefore, in a case where the image logs having an appropriate resolution cannot be generated, the normal processing unit 52 stops the execution of the job, the transaction information creation unit 54 stops the generation of the new transaction information 44 related to the job, and the new transaction information 44 is not transmitted to the other image processing devices 12.

The mining processing unit 56 is a function related to the mining process of the block 40 including the new transaction information 44 transmitted from the image processing device 12 or the other image processing devices 12.

The mining processing unit 56 executes the mining process for the new block 40 which is the block 40 including the new transaction information 44 at a predetermined timing (for example, in a case where the number of pieces of the new transaction information 44 accumulated in the memory 30 is a predetermined number, or at a predetermined time interval). As described above, in the present exemplary embodiment, the mining processing unit 56 executes the mining process in cooperation with the mining processing unit 56 of the other image processing device 12, but the mining processing unit 56 of one image processing device 12 alone may execute the mining process.

The mining process executed by the mining processing unit 56 is as described above. That is, the mining processing unit 56 calculates the hash value of the combination value of one or more pieces of the new transaction information 44, the hash value of the immediately previous block 40, and the nonce. In a case where the hash value as a result of the mining process satisfies a condition that the hash value is smaller than the threshold value set by the difficulty setting unit 58 described later, the mining process is successful. The mining processing unit 56 repeatedly calculates the hash value while changing the nonce until the correct answer hash value is obtained.

In a case where the mining process is successful, the mining processing unit 56 generates the header 42 (see FIG. 4). Specifically, the mining processing unit 56 acquires the version of the software or the protocol related to the blockchain 32, and uses the acquired version as the version information. In addition, the mining processing unit 56 acquires the hash value of the immediately previous block 40, and includes the hash value in the header 42. Further, the mining processing unit 56 acquires the time at which the new block 40 is added to the blockchain 32, and uses the acquired time as the timestamp. In addition, the mining processing unit 56 calculates the average resolution of one or more image logs included in one or more pieces of the transaction information 44 included in the new block 40, and includes the average resolution in the header 42. The proper frequency value is determined in advance and is stored in, for example, the memory 30. The mining processing unit 56 acquires the proper frequency value, and includes the proper frequency value in the header 42.

As described above, the proper frequency value is information indicating the proper value for the frequency of addition of the block 40 to the blockchain 32. In a case where the frequency of addition of the block 40 to the blockchain 32 is too high or too low, inconvenience may occur. For example, in a case where the frequency of addition of the block 40 to the blockchain 32 is too low, the new transaction information 44 not added to the blockchain 32 is accumulated. On the contrary, in a case where the frequency of addition of the block 40 to the blockchain 32 is too high, the difficulty of the mining process is low, and the possibility that the block 40 of the blockchain 32 is tampered with is increased. Therefore, in the present exemplary embodiment, the proper frequency value is determined in advance, and the mining processing unit 56 includes the proper frequency value in the header of each block 40. It should be noted that the proper frequency value is used as the same value for the entire blockchain 32 and is not different for each block 40.

The processor 50 of each image processing device 12 may change the proper frequency value in response to an instruction from the user. That is, the user may be able to change the proper frequency value. As described above, since the same value is used as the proper frequency value for the entire blockchain 32, in a case where the proper frequency value is changed by the user, the proper frequency value for the entire blockchain 32 is changed. For example, an upper limit value and a lower limit value of the proper frequency value that can be set by the user may be determined in advance so that the user does not set an inappropriate proper frequency value.

It should be noted that, in the present exemplary embodiment, the proper frequency value is included in the header 42 of each block 40. However, the information indicating the proper frequency value may be stored in a device (for example, a server) accessible from each image processing device 12 without being included in the header 42. As will be described later, the proper frequency value is referred to by each image processing device 12 in a case where the resolution of the image logs is decided. Therefore, in a case where the proper frequency value is included in the header 42 of the block 40, it is not necessary to separately prepare a device for storing the proper frequency value, and each image processing device 12 may acquire the proper frequency value within the framework of the blockchain 32.

The mining processing unit 56 forms the new block 40 including the generated header 42 and the new transaction information 44 (see FIG. 5). Then, the new block 40 is added to the blockchain 32.

Hereinafter, a process of deciding the resolution of the image logs by the transaction information creation unit 54 will be described in detail. The transaction information creation unit 54 decides the resolution of the image logs to be included in the new transaction information 44, based on the frequency of addition of the plurality of latest blocks 40 added to the blockchain 32. As described above, in the present specification, the block 40 added to the blockchain 32 last time is referred to as the immediately previous block 40, but a plurality of blocks 40 including the immediately previous block 40 added to the blockchain 32 recently are referred to as a plurality of latest blocks 40. In the present specification, the resolution of the image logs included in the new transaction information 44 is referred to as the current resolution. The transaction information creation unit 54 acquires the timestamp from the header 42 of each of the plurality of latest blocks 40. Then, the frequency of addition of the plurality of latest blocks 40 is calculated from an interval between the times indicated by the timestamps of the plurality of latest blocks 40. For example, in a case where the plurality of latest blocks 40 include the first to third blocks 40, the transaction information creation unit 54 sets, as the frequency of addition of the plurality of latest blocks 40, an average value of a difference between a time indicated by the timestamp included in the header 42 of the first block 40 and a time indicated by the timestamp included in the header 42 of the second block 40, and a difference between a time indicated by the timestamp included in the header 42 of the second block 40 and a time indicated by the timestamp included in the header 42 of the third block 40.

The transaction information creation unit 54 sets the current resolution to be lower than the predetermined default resolution in a case where the frequency of addition of the plurality of latest blocks 40 is low, and sets the current resolution to be higher than the default resolution in a case where the frequency of addition of the plurality of latest blocks 40 is high. In a case where the frequency of addition of the plurality of latest blocks 40 is high, the current resolution may be set to be higher than the default resolution.

As the resolution of the image logs is lower, the data volume of the image logs is smaller. Therefore, the amount of calculation for calculating the hash value for the new block 40 including the image logs as the new transaction information 44 is reduced, and thus the amount of calculation until the correct answer hash value for the new block 40 is obtained is also reduced as a result. In other words, the mining time required for the mining process of the new block 40 is reduced. As a result, the frequency of addition of the new block 40 to the blockchain 32 is improved, that is, a decrease in the frequency of addition of the new block 40 (that is, the new transaction information 44) to the blockchain 32 is suppressed.

In the present exemplary embodiment, the transaction information creation unit 54 compares the frequency of addition of the plurality of latest blocks 40 with the proper frequency value described above. Then, in a case where the frequency of addition of the plurality of latest blocks 40 is lower than the proper frequency value, the transaction information creation unit 54 sets the current resolution to be lower than the predetermined default resolution. In particular, in a case where the frequency of addition of the plurality of latest blocks 40 is lower than the proper frequency value, for example, the transaction information creation unit 54 may set the current resolution to be lower than the latest resolution that is the resolution of the image included in the transaction information 44 of the plurality of latest blocks 40.

The transaction information creation unit 54 acquires the resolution of the image logs included in the transaction information 44 of the plurality of latest blocks 40, based on the average resolution of the image logs included in the headers 42 of the plurality of latest blocks 40. For example, in a case where the plurality of latest blocks 40 include the first to third blocks 40, the transaction information creation unit 54 further calculates an average of an average resolution of the image logs indicated by the header 42 of the first block 40, an average resolution of the image logs indicated by the header 42 of the second block 40, and an average resolution of the image logs indicated by the header 42 of the third block 40, and sets the calculated average as the resolution of the image logs included in the transaction information 44 of the plurality of latest blocks 40.

It should be noted that, in the present exemplary embodiment, the average resolution of the image logs is included in the header 42 of each block 40, but the average resolution of the image logs may not be included in the header 42. In this case, the transaction information creation unit 54 can acquire the resolution of each of the image logs included in the plurality of latest blocks 40 by referring to the plurality of pieces of transaction information 44 included in each of the plurality of latest blocks 40. By including the average resolution of the image logs in the header 42 of each block 40, the transaction information creation unit 54 may acquire the resolution of the image included in the transaction information 44 of the plurality of latest blocks 40 by referring to the header 42 without referring to the transaction information 44 of each block 40.

In a case where the frequency of addition of the plurality of latest blocks 40 acquired in this way is lower than the proper frequency value, the transaction information creation unit 54 sets the current resolution to be lower than the latest resolution.

In addition, the transaction information creation unit 54 may set the current resolution to a value calculated based on the latest resolution. In particular, the transaction information creation unit 54 may decide the current resolution based on the relationship between the frequency of addition of the plurality of latest blocks 40 and the proper frequency value and the latest resolution.

For example, the proper frequency value is once every 10 minutes (that is, the new block 40 is added to the blockchain 32 once every 10 minutes). Here, in a case where the frequency of addition of the plurality of latest blocks 40 is once in 40 minutes, the frequency of addition of the plurality of latest blocks 40 is lower than the proper frequency value and is ¼ of the proper frequency value. In this case, the transaction information creation unit 54 sets the current resolution to ½ of the latest resolution (since the data size of the image logs is proportional to the square of the resolution) such that the frequency of addition of the new block 40 approaches the proper frequency value (4 times) and the data size of the image logs to be included in the new transaction information 44 is ¼. On the other hand, in a case where the frequency of addition of the plurality of latest blocks 40 is once in 5 minutes, the frequency of addition of the plurality of latest blocks 40 is equal to or larger than the proper frequency value. In this case, as described above, the transaction information creation unit 54 sets the current resolution as the default resolution (current resolution is not decreased).

The current resolution decided as described above may be a considerably small value. For example, in the above example, in a case where the current resolution is set to ½ of the latest resolution, and the latest resolution is, for example, 20 dpi, the current resolution is 10 dpi. Such image logs having a low resolution cannot be used as the image logs. Therefore, in the present exemplary embodiment, the minimum resolution is determined in advance, and the transaction information creation unit 54 does not generate the image logs in a case where the calculated current resolution is smaller than the minimum resolution. As a result, the transaction information creation unit 54 does not transmit the new transaction information 44. In addition, as described above, in each image processing device 12 according to the present exemplary embodiment, the generation of the image logs of an appropriate resolution is the process completion condition of the job, and thus the normal processing unit 52 interrupts the process of the job related to the image logs in a case where the current resolution is lower than the minimum resolution.

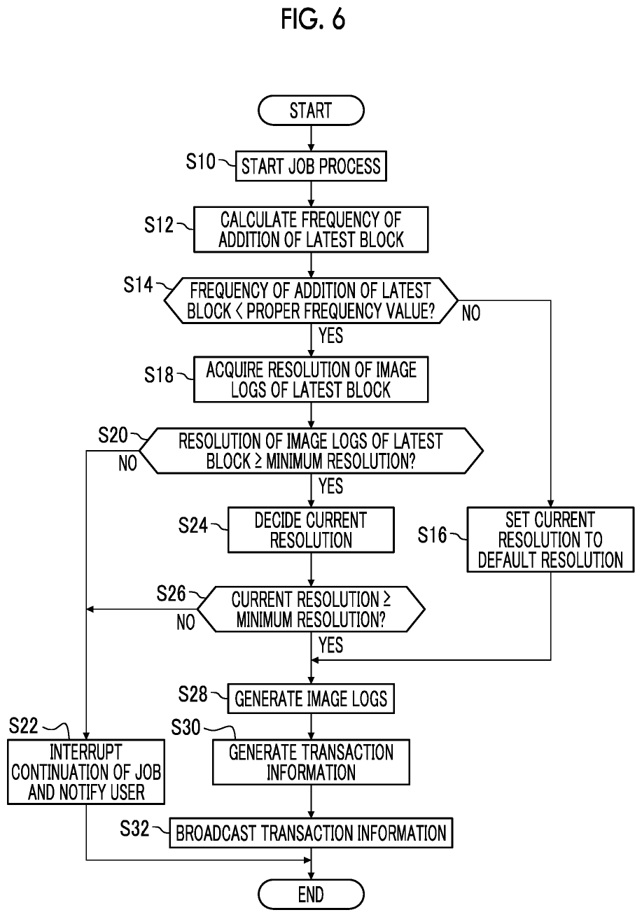

The outline of the image log management system 10 according to the present exemplary embodiment is as described above. Hereinafter, a flow of a process of the image processing device 12 will be described with reference to the flowcharts shown in FIG. 6.

In step S10, the normal processing unit 52 starts the normal process related to the job in accordance with the job input from the user.

In step S12, the transaction information creation unit 54 calculates the frequency of addition of the plurality of latest blocks 40 based on the timestamp included in the header 42 of each of the plurality of latest blocks 40.

In step S14, the transaction information creation unit 54 determines whether or not the frequency of addition of the plurality of latest blocks 40 calculated in step S12 is lower than the proper frequency value. In a case where the frequency of addition of the plurality of latest blocks 40 is equal to or higher than the proper frequency value (in step S14, “No”), the process proceeds to step S16. In step S16, the transaction information creation unit 54 sets the current resolution as the default resolution. It should be noted that, as described above, in step S16, the transaction information creation unit 54 may set the current resolution to be higher than the default resolution. After step S16, the process proceeds to step S28 described later.

In step S14, in a case where the frequency of addition of the plurality of latest blocks 40 is lower than the proper frequency value (in step S14, “Yes”), the process proceeds to step S18. In step S18, the transaction information creation unit 54 acquires the resolution of the image logs included in the transaction information 44 of the plurality of latest blocks 40, based on the average resolution of the image logs included in the headers 42 of the plurality of latest blocks 40.

In step S20, the transaction information creation unit 54 determines whether or not the resolution of the image logs included in the plurality of latest blocks 40 acquired in step S18 is equal to or higher than the minimum resolution. It should be noted that, in each image processing device 12 provided in the image log management system 10, the minimum resolutions may be different from each other. In this case, in a case where the image logs included in the latest block 40 are generated by the other image processing devices 12, the resolution of the image logs included in the latest block 40 may be lower than the minimum resolution in the image processing device 12. In a case where the resolution of the image logs included in the plurality of latest blocks 40 is lower than the minimum resolution (in step S20, “No”), the process proceeds to step S22. In step S22, the normal processing unit 52 interrupts the process of the job for which the process is started in step S10. The normal processing unit 52 notifies the user that the job is interrupted.

In a case where the resolution of the image logs included in the plurality of latest blocks 40 is equal to or higher than the minimum resolution (in step S20, “Yes”), the process proceeds to step S24. In step S24, the transaction information creation unit 54 decides the current resolution based on the relationship between the frequency of addition of the plurality of latest blocks 40 and the proper frequency value, and the latest resolution.

In step S26, the transaction information creation unit 54 determines whether or not the current resolution decided in step S24 is equal to or higher than the minimum resolution. In a case where the current resolution is lower than the minimum resolution, the process proceeds to step S22. In a case where the current resolution is equal to or higher than the minimum resolution, the process proceeds to step S28.

In step S28, the transaction information creation unit 54 generates the image logs for the job for which the process is started in step S10 and which are the image logs having the current resolution decided in step S24.

In step S30, the transaction information creation unit 54 generates new transaction information 44 including the image logs generated in step S28.

In step S32, the transaction information creation unit 54 simultaneously transmits the new transaction information 44 generated in step S30 to the other image processing devices 12 provided in the image log management system 10. In the present exemplary embodiment, a determination is made that the image logs are generated in a case where the new transaction information 44 including the image logs is simultaneously transmitted. Therefore, in a case where the new transaction information 44 is simultaneously transmitted in step S30, the normal processing unit 52 proceeds with the process of the job for which the process is started in step S10 and completes the process. After the process of the job is completed, the normal processing unit 52 notifies the user that the process of the job is completed.

Then, the mining processing unit 56 of each image processing device 12 provided in the image log management system 10 executes the mining process of the new block 40 including the new transaction information 44 simultaneously transmitted in step S32, and in a case where the mining process is successful, the new block 40 is added to the blockchain 32.

Although the exemplary embodiment of the present invention has been described above, the present invention is not limited to the exemplary embodiment and can be subjected to various changes without departing from the gist of the present invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An image log management system comprising:
a plurality of devices that each store a blockchain including a block having transaction information including image logs that are image data indicating process target data, and are communicably connected to each other; and
a processor,
wherein the processor is configured to:
   generate new transaction information including image logs of a resolution decided based on a frequency of addition of a plurality of latest blocks added to the blockchain; and
   transmit the new transaction information to the plurality of devices and add a block having the new transaction information to the blockchain.
      (((2)))

The image log management system according to (((1))),
wherein the processor is configured to:
   in a case where the frequency of addition of the plurality of latest blocks added to the blockchain is lower than a predetermined proper frequency value, generate new transaction information including image logs having a resolution lower than a latest resolution that is a resolution of the image logs included in the transaction information included in the plurality of latest blocks.
      (((3)))

The image log management system according to (((2))),
wherein the processor is configured to:
   set a current resolution that is the resolution of the image logs included in the new transaction information to a value calculated based on the latest resolution.
      (((4)))

The image log management system according to (((3))),
wherein the processor is configured to:
   in a case where the calculated current resolution is lower than a predetermined minimum resolution, not transmit the new transaction information to the plurality of devices and interrupt a process related to the process target data.
      (((5)))

The image log management system according to any one of (((1))) to (((4))),
wherein header information of each block of the blockchain includes information indicating a resolution of the image logs included in the transaction information included in the block.
   (((6)))

The image log management system according to any one of (((2))) to ((4))),
wherein header information of each block of the blockchain includes information indicating the proper frequency value.
   (((7)))

The image log management system according to any one of (((2))) to (((4))),
wherein the processor is configured to:
   change the proper frequency value as an entire blockchain in response to an instruction from a user.
      (((8)))

An image log management program for causing a computer capable of accessing a blockchain that is stored in each of a plurality of devices communicably connected to each other and includes a block having transaction information including image logs that are image data indicating process target data, to execute a process comprising:
generating new transaction information including image logs of a resolution decided based on a frequency of addition of a plurality of latest blocks added to the blockchain, and a latest resolution that is a resolution of the image logs included in the transaction information included in the plurality of latest blocks; and
transmitting the new transaction information to the plurality of devices and add a block having the new transaction information to the blockchain.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image log management system comprising:
a plurality of devices that each store a blockchain including a block having transaction information including image logs that are image data indicating process target data, and are communicably connected to each other; and
a processor,
wherein the processor is configured to:
generate new transaction information including image logs of a resolution decided based on a frequency of addition of a plurality of latest blocks added to the blockchain; and
transmit the new transaction information to the plurality of devices and add a block having the new transaction information to the blockchain.

2. The image log management system according to claim 1,
wherein the processor is configured to:
in a case where the frequency of addition of the plurality of latest blocks added to the blockchain is lower than a predetermined proper frequency value, generate new transaction information including image logs having a resolution lower than a latest resolution that is a resolution of the image logs included in the transaction information included in the plurality of latest blocks.

3. The image log management system according to claim 2,
wherein the processor is configured to:
set a current resolution that is the resolution of the image logs included in the new transaction information to a value calculated based on the latest resolution.

4. The image log management system according to claim 3,
wherein the processor is configured to:
in a case where the calculated current resolution is lower than a predetermined minimum resolution, not transmit the new transaction information to the plurality of devices and interrupt a process related to the process target data.

5. The image log management system according to claim 1,
wherein header information of each block of the blockchain includes information indicating a resolution of the image logs included in the transaction information included in the block.

6. The image log management system according to claim 2,
wherein header information of each block of the blockchain includes information indicating a resolution of the image logs included in the transaction information included in the block.

7. The image log management system according to claim 3,
wherein header information of each block of the blockchain includes information indicating a resolution of the image logs included in the transaction information included in the block.

8. The image log management system according to claim 4,
wherein header information of each block of the blockchain includes information indicating a resolution of the image logs included in the transaction information included in the block.

9. The image log management system according to claim 2,
wherein header information of each block of the blockchain includes information indicating the proper frequency value.

10. The image log management system according to claim 3,
wherein header information of each block of the blockchain includes information indicating the proper frequency value.

11. The image log management system according to claim 4,
wherein header information of each block of the blockchain includes information indicating the proper frequency value.

12. The image log management system according to claim 2,
wherein the processor is configured to:
change the proper frequency value as an entire blockchain in response to an instruction from a user.

13. The image log management system according to claim 3,
wherein the processor is configured to:
change the proper frequency value as an entire blockchain in response to an instruction from a user.

14. The image log management system according to claim 4,
wherein the processor is configured to:
change the proper frequency value as an entire blockchain in response to an instruction from a user.

15. A non-transitory computer readable medium storing an image log management program for causing a computer capable of accessing a blockchain that is stored in each of a plurality of devices communicably connected to each other and includes a block having transaction information including image logs that are image data indicating process target data, to execute a process comprising:
generating new transaction information including image logs of a resolution decided based on a frequency of addition of a plurality of latest blocks added to the blockchain, and a latest resolution that is a resolution of the image logs included in the transaction information included in the plurality of latest blocks; and
transmitting the new transaction information to the plurality of devices and add a block having the new transaction information to the blockchain.

16. An image log management method comprising:
generating new transaction information including image logs of a resolution decided based on a frequency of addition of a plurality of latest blocks added to a blockchain that is stored in each of a plurality of devices communicably connected to each other and includes a block having transaction information including image logs that are image data indicating process target data, and a latest resolution that is a resolution of the image logs included in the transaction information included in the plurality of latest blocks; and
transmitting the new transaction information to the plurality of devices and adding a block having the new transaction information to the blockchain.
